(19) United States
(12) Patent Application Publication
(10) Pub. No.: US 2026/0292950 A1
(43) Pub. Date: Sep. 24, 2026

(54) DEVICE, SYSTEM AND METHODS FOR A CONSTANT CURRENT MODE IN AN INPUT-OUTPUT PAD

(71) Applicant: Microchip Technology Inc., Chandler, AZ (US)

(72) Inventors: John Charais, Oconomowoc, WI (US); Alexandru Vidrasan, Buchurest (RO)

(73) Assignee: Microchip Technology Inc., Chandler, AZ (US)

(21) Appl. No.: 19/246,864

(22) Filed: Jun. 24, 2025

Related U.S. Application Data
(60) Provisional application No. 63/776,674, filed on Mar. 24, 2025.

(51) Int. Cl. H05B 45/345; H05B 45/36

(52) U.S. Cl. CPC H05B 45/345; H05B 45/36

(57) ABSTRACT

A device may include an I/O pad, and the I/O pad may be coupled to an output driver, a current source and a current sink. In operation, the output driver may be disabled by an output driver enable signal and the current source may be enabled by a current source enable signal and may source a constant current to the I/O pad. In operation, the output driver may be disabled by the output driver enable signal and the current sink may be enabled by a current sink enable signal and may sink a constant current from the I/O pad.

### PRIORITY

This application claims priority to commonly owned US Provisional Patent Application 63/776,674 filed on Mar. 24, 2025, the entire contents of which are hereby incorporated by reference for all purposes.

### FIELD OF THE INVENTION

The present disclosure relates to pad structures in a semiconductor device, more specifically to a device, system, and method for a constant-current mode in an input-output (I/O) pad.

### BACKGROUND

In a typical application, a microcontroller may produce a digital output drive at an I/O pad. This output may be a voltage output. There may be times where a current output is desired, such as when driving an LED. The intensity of the LED may be proportional to the current, not the forward voltage of the diode. Therefore it is preferable to drive LEDs with a current source as opposed to a voltage source. Other devices other than LEDs may benefit from a current-mode drive.

Providing reliable matched current sources between different I/O pads may present a challenging problem, as current mirrors and other current generating circuits do not provide reliable currents over long distances or driving heavy loads.

There is a need for devices and systems to provide a constant-current output in an I/O pad.

### SUMMARY

The examples herein enable a device, system, and method for a constant-current mode in an input-output (I/O) pad.

According to one aspect, a device includes an output driver coupled to an I/O pad. The output driver is to be enabled by an output driver enable signal to drive a voltage onto the I/O pad. The device includes a current source coupled to the I/O pad. The current source is to be enabled by a current source enable signal to supply a current to the I/O pad. The device includes a current sink coupled to the I/O pad, wherein the current sink is to be enabled by a current sink enable signal to sink a current from the I/O pad.

Aspects as in the preceding paragraph provide a device including a pull-up resistor coupled to the I/O pad, wherein the pull-up resistor is to be enabled by a pull-up enable signal to selectively supply a voltage to the I/O pad.

Aspects as in one of the preceding two paragraphs provide a device, wherein the device is to be configured as one of a digital input, a digital output, a current source and a current sink.

Aspects as in one of the preceding three paragraphs provide a device, the device including a current source value register, wherein the value of the current supplied by the current source is to be based on a content of the current source value register.

Aspects as in one of the preceding four paragraphs provide a device, the device including a current sink value register, wherein the value of current sink by the current sink is to be based on a content of the current sink value register.

Aspects as in one of the preceding five paragraphs provide a device, the device including an input driver coupled to the I/O pad and a Schmitt trigger coupled to the I/O pad.

Aspects as in the preceding paragraph provide a device, the device including a hysteresis register, wherein the Schmitt trigger is to provide hysteresis to a signal at the I/O pad, an amount of hysteresis to be based on a content of the hysteresis register.

Aspects as in one of the preceding two paragraphs provide a device, the device including an internal circuit, wherein the input driver is to provide an input signal to the internal circuit.

Aspects as in one of the preceding seven paragraphs provide a device, wherein the current source comprises a current mirror.

Aspects as in one of the preceding eight paragraphs provide a device, wherein the current sink comprises a current mirror.

Aspects as in one of the preceding nine paragraphs provide a device, wherein the current source comprises an amplifier.

Aspects as in one of the preceding ten paragraphs provide a device, wherein the current sink comprises an amplifier.

According to another aspect, a system includes a microcontroller comprising an I/O circuit. The I/O circuit includes an output driver coupled to an I/O pad. The I/O pad includes a current source coupled to the I/O pad, the current source to be enabled based on a current source enable signal. The I/O pad includes a current sink coupled to the I/O pad, the current sink to be enabled based on a current sink enable signal. The I/O pad includes a load coupled to the I/O pad. The microcontroller is to configure the I/O pad and to enable the current source and the current sink based on a predetermined condition.

Aspects as in the preceding paragraphs provide for a system, wherein the load comprises at least one light emitting diode (LED), and the current source is to provide a current to drive the LED.

Aspects as in the preceding two paragraphs provide for a system, wherein the load comprises a communication receiver and the microcontroller is to enable the current source and the current sink in a predetermined sequence to transmit one or more data bits to the communication receiver.

Aspects as in the preceding three paragraphs provide for a system, the system comprising an internal circuit and comprising an input driver coupled to the I/O pad, wherein the input driver is to provide an input signal to the internal circuit.

Aspects as in the preceding four paragraphs provide for a system, the system comprising a Schmitt trigger coupled to the I/O pad, wherein the Schmitt trigger is to provide hysteresis to a signal at the I/O pad.

Aspects as in the preceding five paragraphs provide for a system, the system comprising a hysteresis register, wherein the Schmitt trigger is to provide an amount of hysteresis to a signal at the I/O pad based on a content of the hysteresis register.

According to another aspect, a method includes steps of: disabling an output driver, an input driver and a Schmitt trigger, wherein the output driver, the input driver and the Schmitt trigger part of an I/O pad, and enabling one of a current source and a current sink, wherein the current source and current sink are part of the I/O pad. Enabling the current source is to source current at the I/O pad. Enabling the current sink it to sink current at the I/O pad.

Aspects as in the preceding paragraph provide for a method, wherein the enabling one of a current source and a current sink comprises enabling one of a current source enable signal and a current sink enable signal.

### BRIEF DESCRIPTION OF THE DRAWINGS

FIG. 1 illustrates one of various examples of a device for a constant current output in an I/O pad.

FIG. 2 illustrates one of various examples of a system for a constant current output in an I/O circuit.

FIG. 3 illustrates a method of providing a DC current source and current sink at an I/O pad.

### DETAILED DESCRIPTION

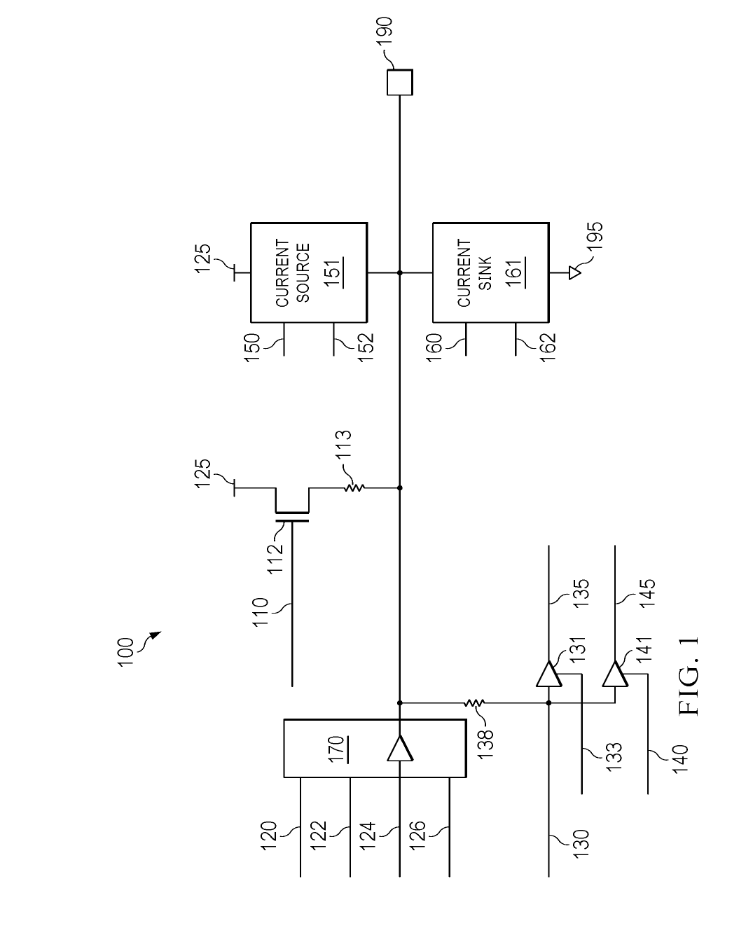

FIG. 1 illustrates one of various examples of a device 100 for a constant current output in an I/O pad. Device 100 may be an I/O pad. Portions of device 100 may be in an I/O pad, and portions of device 100 may be outside the I/O pad.

Device 100 may include pull-up enable signal 110. Pull-up enable signal 110 may be input to pull-up device 112. When pull-up enable signal 110 is in the active state, pull-up enable signal 110 may drive a voltage at the gate of pull-up device 112 to enable pull-up device 112 and pull-up device 112 may drive a voltage onto I/O pad 190. Resistor 113 may control the current pulled through pull-up device 112 when pull-up device 112 is enabled.

Device 100 may include output driver 170. Output driver 170 may drive a voltage onto I/O pad 190 based on one or more inputs to output driver 170. Output driver 170 is illustrated as an amplifier, but this is not intended to be limiting.

As one of various examples, data output enable signal 120 may be input to output driver 170. Data output enable signal 120 may enable data output from output driver 170. As one of various examples, driver enable signal 122 may be input to output driver 170. Driver enable signal 122 may enable output driver 170. As one of various examples, data output signal 124 may be input to output driver 170. Data output signal 124 may control a data output level from output driver 170. A logic high level at data output signal 124 may enable a high voltage output at I/O pad 190, and a logic low level at data output signal 124 may enable a low voltage output at I/O pad 190. As one of various examples, slew enable signal 126 may be input to output driver 170. Slew enable signal 126 may enable one or more slew rates in output driver 170 and may control a rate of change of voltage at I/O pad 190.

Device 100 may include high voltage analog input signal 130. High voltage analog input signal 130 may provide a connection between I/O pad 190 and internal circuitry when device 100 is configured as an input pad. A voltage on I/O pad 190 may be coupled to high voltage analog input 130 via isolation resistor 138. High voltage analog input 130 may be coupled to Transistor-Transistor Logic (TTL) driver 131. TTL driver 131 may be enabled by TTL enable signal 133. An output of TTL driver 131 may be coupled to external circuitry via TTL output 135. The example illustrated in FIG. 1 utilizes a TTL-level driver, but this is not intended to be limiting. Other logic levels may be output at TTL output 135. TTL driver 131 may be termed an input driver.

High voltage analog input 130 may be coupled to Schmitt trigger 141. Schmitt trigger 141 may be enabled by Schmitt trigger enable signal 140. Schmitt trigger 141 may implement hysteresis at high voltage analog input 130. An output of Schmitt trigger 141 may be coupled to external circuitry via Schmitt trigger output 145. Hysteresis register 142 may control an amount of hysteresis to be provided by Schmitt trigger 141.

Device 100 may include current source 151. Current source 151 may be coupled to supply 125. Current source enable signal 150 may enable current source 151. Current source 151 may be based on a current mirror, a bandgap reference, a voltage reference across an impedance, or another type of current source not specifically mentioned. In operation, a microcontroller or software algorithm may assert current source enable signal 150. Current source 151 may be activated and may source a Direct Current (DC) current at I/O pad 190. I/O pad 190 may be coupled to external circuits not shown in FIG. 1.

Current source 151 may include current source value register 152. Current source value register 152 may control the level of current sourced by current source 151. In one of various examples, current source value register 152 may be a register setting and may provide 16 different current settings. In one of various examples, the contents of current source value register 152 may provide current source values from a minimum of 0.5mA to a maximum of 8mA in 0.5mA steps.

Device 100 may include current sink 161. Current sink 161 may be coupled to ground connection 195. Current sink enable signal 160 may enable current sink 161. Current sink 161 may be based on a current mirror, a bandgap reference, a voltage reference across an impedance, or another type of current sink not specifically mentioned. In operation, a microcontroller or software algorithm may assert current sink enable signal 160.

Current sink 161 may be activated and may sink a Direct Current (DC) current from I/O pad 190. Current sink 161 may include current sink value register 162. Current sink value register 162 may control the level of current sunk by current sink 161. In one of various examples, current sink value register 162 may be a register setting and may provide 16 different current sink settings. In one of various examples, current sink value register 162 may provide current sink values from a minimum of 0.5mA to a maximum of 8mA in 0.5mA steps.

I/O pad 190 may be coupled to external circuits not shown in FIG. 1. In one of various examples, I/O pad 190 may be coupled to one or more light emitting diodes (LEDs), and current source 151 may drive the LEDs. Current source value register 152 may control the brightness of LEDs driven by current source 151.

In operation, output driver 170 may be disabled by data output enable signal 120 and driver enable signal 122. With the output driver disabled, current source 151 may be enabled by current source enable signal 152 and device 100 may operate as a current source, or current sink 161 may be enabled by current sink enable signal 162 and device 100 may operate as a current sink. With the output driver disabled, and neither of current source 151 and current sink 161 are enabled, device 100 may operate as in input and high voltage analog input 130, TTL output 135 and Schmitt trigger output 145 may be coupled to internal circuitry. Current source 151 may provide a constant value of current. Current sink 161 may sink a constant value of current.

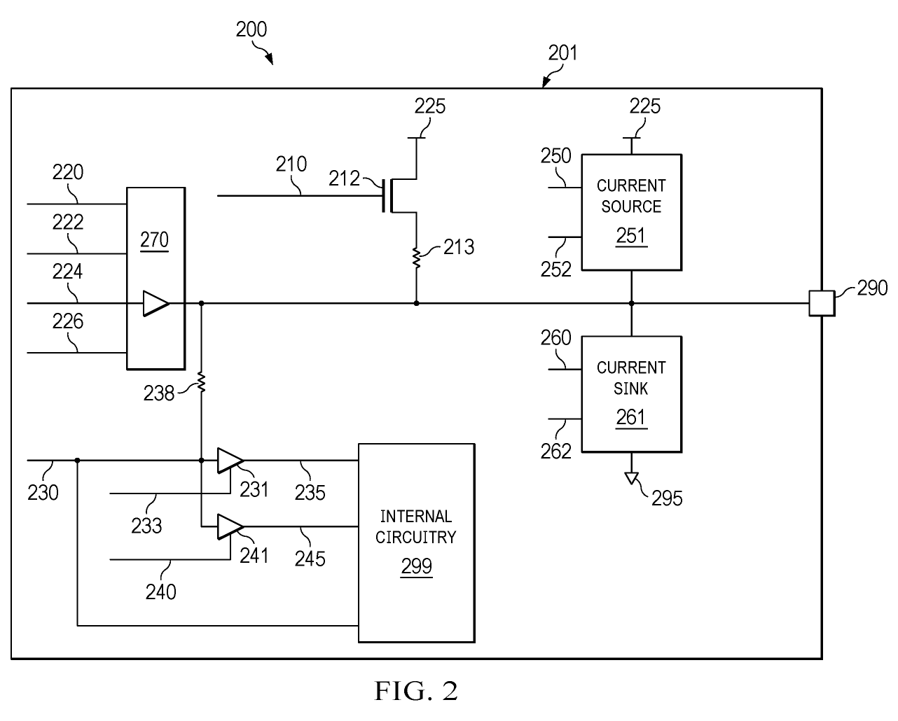

FIG. 2 illustrates one of various examples of a system 200 to enable a constant current output.

System 200 may include device 201. Device 201 may be a semiconductor device manufactured on a single silicon substrate. Device 201 may be a microcontroller including a central processing unit (CPU), one or more peripherals, and other components not explicitly shown.

Device 201 may include pull-up enable signal 210. Pull-up enable signal 210 may be input to pull-up device 212. When pull-up enable signal 210 is in the active state, pull-up enable signal 210 may drive a voltage at the gate of pull-up device 212 to enable pull-up device 212 and pull-up device 212 may drive a voltage onto I/O pad 290. Resistor 213 may control the current pulled through pull-up device 212 when pull-up device 212 is enabled. I/O pad 290 may be coupled to a load. The load may be an external circuit.

System 200 may include output driver . Output driver 270 may drive a voltage onto I/O pad 290 based on one or more inputs to output driver 270. Output driver 270 is illustrated as an amplifier, but this is not intended to be limiting.

As one of various examples, data output enable signal 220 may be input to output driver 270. Data output enable signal 220 may enable data output from output driver 270. As one of various examples, driver enable signal 222 may be input to output driver 270. Driver enable signal 222 may enable output driver 270. As one of various examples, data output signal 224 may be input to output driver 270. Data output signal 224 may control a data output level from output driver 270. A logic high level at data output signal 224 may enable a high voltage output at I/O pad 290, and a logic low level at data output signal 224 may enable a low voltage output at I/O pad 290. As one of various examples, slew enable signal 226 may be input to output driver 270. Slew enable signal 226 may enable one or more slew rates in output driver 270 and may control a rate of change of voltage at I/O pad 290.

System 200 may include high voltage analog input signal 230. High voltage analog input signal 230 may provide a connection between I/O pad 290 and internal circuitry 299 when system 200 is configured as an input pad. A voltage on I/O pad 290 may be coupled to high voltage analog input 230 via isolation resistor 238. High voltage analog input 230 may be coupled to Transistor-Transistor Logic (TTL) driver 231. TTL driver 231 may be enabled by TTL enable signal 233. An output of TTL driver 231 may be coupled to external circuitry via TTL output 235. The example illustrated in FIG. 1 utilizes a TTL-level driver, but this is not intended to be limiting. Other logic levels may be output at TTL output 235, and TTL output 235 may enable system 200 to operate as a digital input pad. TTL driver 231 may be termed an input driver.

High voltage analog input 230 may be coupled to Schmitt trigger 241. Schmitt trigger 241 may be enabled by Schmitt trigger enable signal 240. Schmitt trigger 241 may implement hysteresis at high voltage analog input 230. An output of Schmitt trigger 241 may, via level shifter 242, be coupled to external circuitry via Schmitt trigger output 245.

High voltage analog input 230 may be coupled to internal circuitry 299. Internal circuitry 299 may include level shifters or other circuitry to change the voltage of high voltage analog input 230 and to otherwise interface high voltage analog input 230 to internal circuitry 299. TTL output 235 may be coupled to internal circuitry 299. Internal circuitry 299 may include level shifters or other circuitry to change the voltage of TTL output 235 and to otherwise interface TTL output 235 to internal circuitry 299. Schmitt trigger output 245 may be coupled to internal circuitry 299. Internal circuitry 299 may include level shifters or other circuitry to change the voltage of Schmitt trigger output 245 and to otherwise interface Schmitt trigger output 245 to internal circuitry 299. Internal circuitry 299 may be termed an internal circuit.

System 200 may include current source 251. Current source 251 may be coupled to supply 225. Current source enable signal 250 may enable current source 251. Current source 251 may be based on a current mirror, a bandgap reference, a voltage reference across an impedance, or another type of current source not specifically mentioned. In operation, a microcontroller or software algorithm may assert current source enable signal 250. Current source 251 may be activated and may source a Direct Current (DC) current at I/O pad 290. Current source 251 may include current source value register 252. Current source value register 252 may control the level of current sourced by current source 251. I/O pad 290 may be coupled to external circuits not shown in FIG. 2.

System 200 may include current sink 261. Current sink 261 may be coupled to ground connection 295. Current sink enable signal 260 may enable current sink 261. Current sink 261 may be based on a current mirror, a bandgap reference, a voltage reference across an impedance, or another type of current sink not specifically mentioned. In operation, a microcontroller or software algorithm may assert current sink enable signal 260. Current sink 261 may be activated and may sink a Direct Current (DC) current from I/O pad 290. Current sink 261 may include current sink value register 262. Current sink value register 262 may control the level of current sunk by current sink 261.

I/O pad 290 may be coupled to one or more load devices . In one of various examples, I/O pad 290 may be coupled to one or more light-emitting diodes (LEDs), and current source 251 may drive the LEDs. Current source value register 252 may control the brightness of LEDs driven by current source 251. In another example, I/O pad 290 may be coupled to a communication receiver, the current source and current sink to transmit one or more data bits to the communication receiver. The current source and current sink may be enabled and disabled in sequence, based on a predetermined condition, to transmit one or more data bits to the communication receiver.

FIG. 2 illustrates a system 200 which may enable an I/O pad 290 which may support the following interfaces to internal circuitry 299: (1) a high voltage input, via high voltage analog input 230, (2) a low-voltage input, via TTL output 235, and (3) a Schmitt trigger, via Schmitt trigger output 245. System 200 may additionally support current source 251 and current sink 261 and may drive LEDs and other loads with a constant current. In this manner, system 200 may include I/O pad 290 which may be configured as an input, an output, a current source or a current sink.

In operation, output driver 270 may be disabled by data output enable signal 220 and driver enable signal 222. With output driver 270 disabled, current source 251 may be enabled by current source enable signal 252 and system 200 may operate as a current source, or current sink 261 may be enabled by current sink enable signal 262 and system 200 may operate as a current sink. With output driver 270 disabled, and neither of current source 251 and current sink 261 enabled, system 200 may operate as in input and high voltage analog input 230, TTL output 235 and Schmitt trigger output 245 may drive one or more circuits within internal circuitry 299.

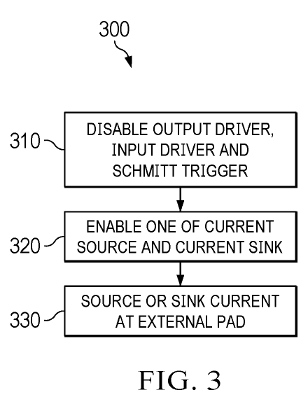

FIG. 3 illustrates a method of providing a DC current source and current sink at an I/O pad. The I/O pad may be coupled to an external circuit.

At operation 310, an output driver within the I/O pad may be disabled. The output driver may be output driver 170 as described and illustrated in reference to FIG. 1. The output driver may be output driver 270 as described and illustrated in reference to FIG. 2. Additionally, an input driver and a Schmitt trigger may be disabled.

At operation 320, one of a current source and a current sink may be enabled. The current source may be current source 151 as described and illustrated in reference to FIG. 1. The current sink may be current sink 160 as described and illustrated in reference to FIG. 1.

At operation 330, the I/O pad may source or sink current at an external circuit based on operation 320.

1. A device comprising:
an output driver coupled to an Input-Output (I/O) pad, wherein the output driver is to be enabled by an output driver enable signal to drive a voltage onto the I/O pad;
a current source coupled to the I/O pad, wherein the current source is to be enabled by a current source enable signal to supply a current to the I/O pad; and
a current sink coupled to the I/O pad, wherein the current sink is to be enabled by a current sink enable signal to sink a current from the I/O pad.

2. The device as claimed in claim 1, comprising a pull-up resistor coupled to the I/O pad, wherein the pull-up resistor is to be enabled by a pull-up enable signal to selectively supply a voltage to the I/O pad.

3. The device as claimed in claim 1, wherein the device is to be configured as one of a digital input, a digital output, a current source and a current sink.

4. The device as claimed in claim 1, comprising a current source value register, wherein the value of the current supplied by the current source is to be based on a content of the current source value register.

5. The device as claimed in claim 1, comprising a current sink value register, wherein the value of current sunk by the current sink is to be based on a content of the current sink value register.

6. The device as claimed in claim 1, comprising an input driver coupled to the I/O pad and a Schmitt trigger coupled to the I/O pad.

7. The device as claimed in claim 6, comprising a hysteresis register, wherein the Schmitt trigger is to provide hysteresis to a signal at the I/O pad, an amount of hysteresis to be based on a content of the hysteresis register.

8. The device as claimed in claim 6, comprising an internal circuit, wherein the input driver is to provide an input signal to the internal circuit.

9. The device as claimed in claim 1, wherein the current source comprises a current mirror.

10. The device as claimed in claim 1, wherein the current sink comprises a current mirror.

11. The device as claimed in claim 1, wherein the current source comprises an amplifier.

12. The device as claimed in claim 1, wherein the current sink comprises an amplifier.

13. A system comprising:
a microcontroller comprising an I/O circuit, the I/O circuit comprising:
an output driver coupled to an I/O pad;
a current source coupled to the I/O pad, the current source to be enabled based on a current source enable signal;
a current sink coupled to the I/O pad, the current sink to be enabled based on a current sink enable signal; and
a load coupled to the I/O pad,
wherein the microcontroller is to configure the I/O pad and to enable the current source and the current sink based on a predetermined condition.

14. The system as claimed in claim 13, wherein the load comprises at least one light emitting diode (LED), and the current source is to provide a current to drive the LED.

15. The system as claimed in claim 13, wherein the load comprises a communication receiver and the microcontroller is to enable the current source and the current sink in a predetermined sequence to transmit one or more data bits to the communication receiver.

16. The system as claimed in claim 13, comprising an internal circuit and comprising an input driver coupled to the I/O pad, wherein the input driver is to provide an input signal to the internal circuit.

17. The system as claimed in claim 13, comprising a Schmitt trigger coupled to the I/O pad, wherein the Schmitt trigger is to provide hysteresis to a signal at the I/O pad.

18. The system as claimed in claim 13, comprising a hysteresis register, wherein the Schmitt trigger is to provide an amount of hysteresis to a signal at the I/O pad based on a content of the hysteresis register.

19. A method comprising:
disabling an output driver, an input driver and a Schmitt trigger, wherein the output driver, the input driver and the Schmitt trigger part of an I/O pad; and
enabling one of a current source and a current sink, wherein the current source and current sink are part of the I/O pad,
wherein enabling the current source is to source current at an external circuit, and
wherein enabling the current sink is to sink current at the external circuit.

20. The method as claimed in claim 19, wherein the enabling one of a current source and a current sink comprises enabling one of a current source enable signal and a current sink enable signal.
